(19) United States
(12) Patent Application Publication
(10) Pub. No.: US 2004/0189687 A1
(43) Pub. Date: Sep. 30, 2004

(54) Image displaying method, order receiving device, and system having the order receiving device

(75) Inventor: Kazuki Yamamoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/807,353

(22) Filed: Mar. 24, 2004

(30) Foreign Application Priority Data
Mar. 25, 2003 (JP) 2003-083450

(51) Int. Cl. G09G 5/00

(52) U.S. Cl. 345/716

(57) ABSTRACT

A digital still camera produces data files of the plural image frames by picking up an object, and produces chronological information in relation to pickup of the plural image frames. In an image displaying method, the plural image frames are grouped into first to Nth image groups according to a result of comparison between the plural image frames in the chronological information. N principal image frames derived from respectively the first to Nth image groups are displayed, and checked for selection of one specified image group among the first to Nth image groups. After selection of the specified image group, intra-group image frames among the image frames and constituting the specified image group are displayed, and checked for selection of one specified image frame. Consequently, any intended image frame can be selected among the numerous ones very efficiently.

### BACKGROUND OF THE INVENTION

1. Field of the Invention

The present invention relates to an image displaying method, an order receiving device and a system adapted to receiving an order. More particularly, the present invention relates to an image displaying method, an order receiving device and a system adapted to receiving an order, in which a user or customer can select his or her intended image frames with high efficiency even with a great number of stored image frames.

2. Description Related to the Prior Art

A digital camera, such as digital still camera is widely used. An object is photographed to produce image data, which is written to a memory card as an external storage medium. A printer of a home use known in the art, or image forming device, is available to produce prints of the images from the digital still camera. Furthermore, commercial service of digital printing is available, according to which prints can be produced with high quality and also at a low cost. The digital printing service is provided at each one of local photo shops in connection with a photofinisher. An order receiving device is installed in the photo shop, is operated by the user or an attendant, to accept a request from the user. Note that a photofinisher may be a dealer, printing agent, or branch or division of a manufacturer.

A card reader is incorporated in the order receiving device for reading the image data stored in the memory card. When the memory card is set at the card reader, the image data is read from the memory card sequentially and retrieved by the order receiving device operating digitally. So a display panel is driven to indicate an image according to the image data. A user views the display panel, selects a desired one of the images, and inputs intended information such as a printing size, the number of prints and the like, to place an order. The image data of the selected image is written to a separate storage medium, which is forwarded to the photofinisher. Alternatively, the image data is sent through the Internet or other network to the photofinisher. Upon the receipt, the photofinisher prints images according to the image data and the intended information. The prints are provided to the user at the final stage of the printing operation.

Also, there is a type of the order receiving device provided with the printer, or there is an apparatus in which the order receiving device and the image forming device are unified in a form of a single machine. This type of the order receiving device sends the image data of an image to the image forming device directly as desired by a user, for the purpose of producing a print. This is advantageous in no need of sending the image data to the photofinisher. Prints can be produced immediately after placing an order.

At the time of receiving an order in the order receiving device, it is necessary to read image data from the memory card serially to display images. A user is encouraged to select images to be printed. In FIG. 12, a first image frame 102 is indicated in a display panel 100 of the order receiving device. Then image data of second, third, fourth, fifth and sixth image frames 104, 106, 108, 110 and 112 are read out one after another. Those image frames are indicated in a serially arranged form. A seventh image frame 114 is indicated at a first location of the second line. An eighth image frame 116 and succeeding ones are arranged next to the seventh image frame 114.

Let the user desire a print of an eighteenth image frame 118. Image data of 17 preceding image frames are read first, before image data of the eighteenth image frame 118 is read. The eighteenth image frame 118 is displayed and can be selected only after reading the 17 image frames. During the time of reading the 17 preceding image frames, he or she must await the chance for the selection in front of the order receiving device. Furthermore, the display panel 100 indicates very numerous image frames even at a single time for the user to observe those and to compare them with one another. This great number of the image frames causes a serious problem in the inefficiency of placing an order.

Owing to technical innovation spread widely, capacity of storage of the memory card has been raised considerably even to a degree of capability of storing an image of several hundreds of image frames. In future, one memory card of an easily available type may be capable of storing several thousands of image frames. A user must endure very long waiting time required for reading or retrieving image frames of numerous image frames according to the huge number of image frames recordable in the memory card. Time required for searching and viewing image frames for the purpose of selection is likely to become excessively long because of limited performance of indication in the display panel. An order for printing cannot be placed with high efficiency according to a user's intention.

### SUMMARY OF THE INVENTION

In view of the foregoing problems, an object of the present invention is to provide an image displaying method, an order receiving device and a system adapted to receiving an order, in which a user or customer can select his or her intended image frames with high efficiency even with a great number of stored image frames.

In order to achieve the above and other objects and advantages of this invention, an image displaying method of displaying plural image frames is provided. A digital camera is combined therewith, produces data files of the plural image frames by picking up an object, and produces chronological information in relation to pickup of the plural image frames. In the image displaying method, the plural image frames are grouped into first to Nth image groups according to a result of comparison between the plural image frames in the chronological information, where N is an integer of two or more. N principal image frames derived from respectively the first to Nth image groups are displayed, the N principal image frames being checked and adapted to selection of one specified image group among the first to Nth image groups. After selection of the specified image group, intra-group image frames among the image frames and constituting the specified image group are displayed, the intra-group image frames being checked and adapted to selection of one specified image frame.

The N principal image frames are arranged in a first direction on the display panel. The intra-group image frames are arranged in a second direction crosswise to the first direction on the display panel.

Also, data files of the N principal image frames derived from the first to Nth image groups are read to display the N principal image frames. After the principal image frames are read, data files of remaining image frames in the first to Nth image group and succeeding to the principal image frames are read. After the specified image group is selected, remaining data files of the intra-group image frames succeeding to the principal image frame in the specified image group are read.

The remaining image frames are read in a sequence of the chronological information thereof.

The reading of the remaining image frames includes reading remaining image frames included in a Kth image group, where K is from 1 to N−1. After the Kth image group, remaining image frames included in a (K+1)th image group and succeeding to the principal image frame are read.

In one preferred embodiment, the reading of the remaining image frames includes reading a Pth image frame among remaining image frames included in respectively the first to Nth image groups, where P is smaller than a greatest number of frame numbers of group image frames of respectively the first to Nth image groups. After the Pth image frame, a (P+1)th image frame is read, among remaining image frames included in respectively the first to Nth image groups and succeeding to the Pth image frame according to the chronological information thereof.

If the specified image group is selected during the reading of the remaining image frames succeeding to the principal image frames, then the reading of the remaining image frames is interrupted, and the intra-group image frames are read with priority.

Furthermore, frame amount information is displayed in association with the principal image frames, the frame amount information representing an amount of image frames included in respectively the first to Nth image groups.

The frame amount information is in a patterned form or indicia form, has a size according to the amount, and is positioned close to the principal image frames.

The first to Nth image groups are associated with respectively first to Nth chronological zones distinct from one another.

Furthermore, zone information of the first to Nth chronological zones of the first to Nth image groups is displayed in association with the N principal image frames thereof.

After the data files of the image frames of the first to Nth image groups are read, images frames included in each of the first to Nth image groups are subjected to evaluation relative to one another in order to select the principal image frames.

Furthermore, the chronological information of a first one of the plural image frames is compared with the chronological information of a second one of the plural image frames directly next thereto, so as to obtain a time difference between values of the chronological information. If the time difference is less than predetermined time according to evaluation of the time difference by comparison, then it is determined that the second image frame is included in an image group including the first image frame. If the time difference is equal to or more than the predetermined time according to evaluation of the time difference by comparison, then it is determined that the second image frame is included in an image group directly next to the image group including the first image frame.

A pointing pattern is displayed on the display panel in a shiftable manner in the first direction, and adapted to designating one of the N principal image frames.

The pointing pattern is further shiftable in the second direction, and adapted to designating one of the intra-group image frames.

In another preferred embodiment, the pointing pattern is stationary relative to the second direction, the intra-group image frames are displayed in a shiftable manner in the second direction, and one of the intra-group image frames is designated and selected when set at the pointing pattern.

The second direction is erect relative to the first direction.

The chronological information is constituted by an index file, and related to at least one of time, date and year of the pickup of the plural image frames.

In one preferred embodiment, furthermore, the principal image frame is determined for one of the image groups of which reading of the image data of the intra-group image frames is completed. According to a result of the determining step, the principal image frame is displayed on the display panel in a renewed manner.

Those determining and displaying steps are executed periodically at a regular period.

The principal image frame determined in the determining step is a frame of a human image.

Furthermore, a plurality of the intra-group image frames are combined for one of the image groups of which reading of the image data of the intra-group image frames is completed, to produce a combined image frame. The combined image frame is displayed on the display panel in a renewed manner for the principal image frame.

According to one aspect of the invention, an order receiving device is combined with a digital camera, for receiving an order of image frame printing. The digital camera produces data files of plural image frames by picking up an object, and produces chronological information in relation to pickup of the plural image frames. The order receiving device includes a chronology analyzer for analyzing the chronological information, in order to group the plural image frames into first to Nth image groups, where N is an integer of two or more. A selector designates one of the first to Nth image groups. A display panel selectively displays the plural image frames. A controller controls the display panel according to the data files and an output of the chronology analyzer, for displaying N principal image frames in a form arranged in a first direction, the N principal image frames being derived from respectively the first to Nth image groups, wherein the controller enables the selector, and after selection of one specified image group among the first to Nth image groups at the selector, displays intra-group image frames among the image frames and constituting the specified image group.

According to another aspect of the invention, a system for image frame printing includes the above-described digital camera and order receiving device.

According to the present invention, a user or customer can select his or her intended image frames with high efficiency even with a great number of stored image frames, because principal image frames are first displayed in a chronologically classified form before transferring the remaining data files of the image frames.

### BRIEF DESCRIPTION OF THE DRAWINGS

The above objects and advantages of the present invention will become more apparent from the following detailed description when read in connection with the accompanying drawings, in which:

FIG. 1 is a block diagram schematically illustrating a digital still camera and an order receiving device in combination with the same;

FIG. 2 is a chart illustrating data files and an index files stored in a memory card;

FIG. 3 is a chart illustrating chronological information included in the index file;

FIG. 4 is a flow chart illustrating a process of displaying image frames;

FIG. 5A is a timing chart illustrating a first half of a process of reading data files of image data;

FIG. 5B is a timing chart illustrating a second half of the reading process of FIG. 5A;

FIG. 6 is an explanatory view in plan, illustrating a displayed state of a series of principal images frames;

FIG. 7 is an explanatory view in plan, illustrating a displayed state similar to FIG. 6 but upon selection of a specified image group;

FIG. 8 is an explanatory view in plan, illustrating a displayed state of intra-group image frames of the specified image group;

FIG. 9 is an explanatory view in plan, illustrating another preferred embodiment in which a series of intra-group image frames are vertically scrolled;

FIG. 10 is an explanatory view in plan, illustrating still another preferred embodiment in which a series of intra-group image frames extends obliquely;

FIG. 11A is a timing chart illustrating a first half of another preferred process of reading data files of image data;

FIG. 11B is a timing chart illustrating a second half of the reading process of FIG. 11A;

FIG. 12 is an explanatory view in plan, illustrating a series of displayed image frames according to the prior art.

### DETAILED DESCRIPTION OF THE PREFERRED EMBODIMENT(S) OF THE PRESENT INVENTION

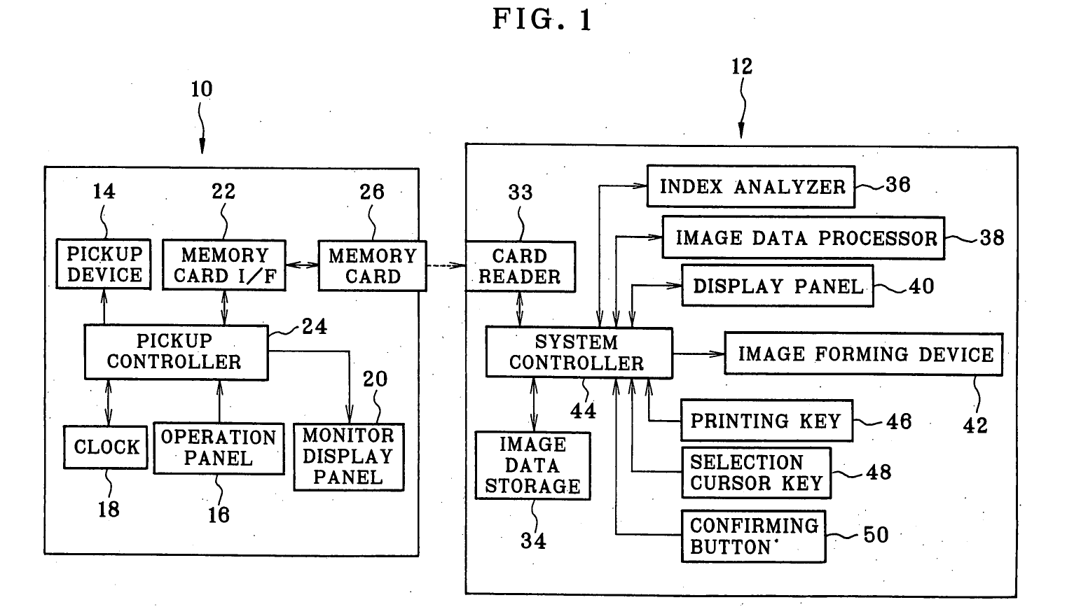

In FIG. 1, an order receiving device 12 of the invention is depicted, in association with a digital still camera 10 as a digital camera. The digital still camera 10 includes a pickup device 14, an operation panel 16, a clock 18, a monitor display panel 20 such as LCD (liquid crystal display), a memory card interface (I/F) 22, and a pickup controller 24. The pickup device 14 photographs an object, to obtain image data of an object image. The operation panel 16 includes a shutter release button, a selection button and the like. The clock 18 is basically constituted by an oscillator, and measures time, date and other chronological information. The pickup controller 24 controls all of those elements.

A memory card 26 is used with the digital still camera 10, and removably connected with its input terminal. The memory card 26 is an external storage medium for storing data. Examples of the memory card 26 are smart media, xD-picture card, memory stick, compact flash, SD card, micro drive (all of which are trade names), and the like.

The pickup device 14 includes a taking lens, an image sensor, an A/D converter, an image processing circuit and the like. The pickup device 14 photoelectrically converts the object image to a signal in response to depression of the shutter release button, and subjects the signal to signal processing to obtain image data, examples of the signal processing being matrix calculation, white balance adjustment, gamma correction and the like. The pickup controller 24 subjects image data to processing of compression to a predetermined format, for example the JPEG (Joint Photographic Experts Group) format, and additionally associates chronological information with the compressed image data, to produce data files of the image data. An example of format of data files of the image data is the Exchangeable Image File Format known in the art. The produced data files of the image data are sent through the memory card interface 22, and written to the memory card 26. When a user operates the operation panel 16 to enter a signal of command for image reproduction, the pickup controller 24 reads or retrieves data files of image data from the memory card 26 in a manner desired by him or her. The monitor display panel 20 is controlled to display the images.

At the time of picking up an object, the pickup controller 24 accesses the clock 18 to obtain chronological information, and writes the same to a memory for the data files as a portion of photographing information. Also, the pickup controller 24 produces an index file (IDX file) or information of a relationship between the data files and the chronological information. At each time of photographing the object, the pickup controller 24 writes information as a portion of the index file, the information including the data file names and the chronological information of time, date or year.

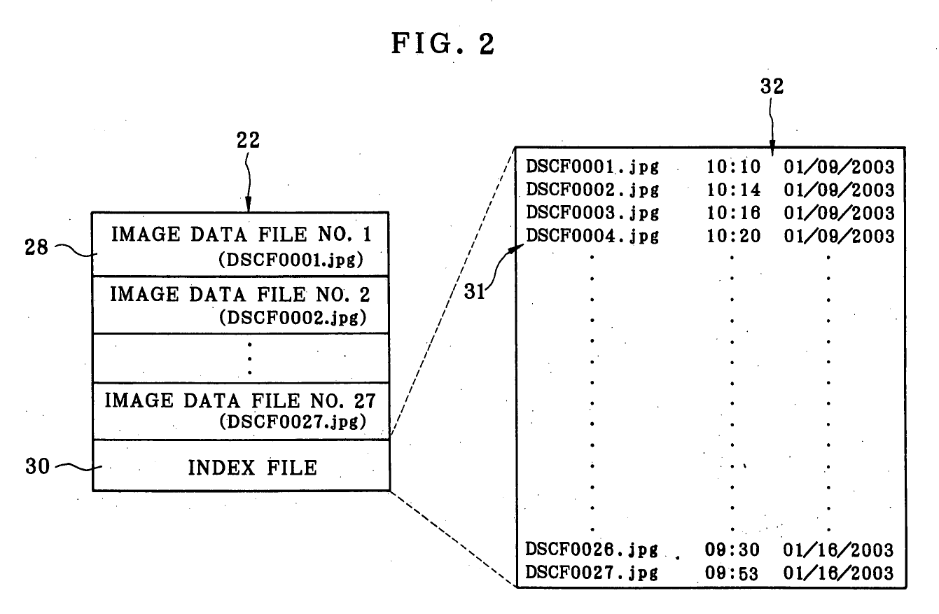

In FIG. 2, various files of data stored in the memory card 26 are illustrated, and include plural data files 28 or image data files for 27 image frames, and an index file 30. Each of the data files 28 is provided with one file name, for example DSCF0001.jpg. In the index file 30, there are portions including data file names 31 of respectively the data files, and chronological information 32 of pickup of the image frames. The data file names 31 are located serially in a rising order of the date and time chronologically.

In FIG. 1, the order receiving device 12 includes a card reader 33, an image data storage 34, an index analyzer 36 or chronology analyzer, an image data processor 38, and a display panel 40. There is an image forming device 42 for printing, connected with the order receiving device 12. A system controller 44 controls those for the order receiving operation. The order receiving device 12 also has a keyboard or operation panel, which has a printing key 46, a selection cursor key 48 as a selector, and a confirming button 50 for the selection. A user can input a signal of selection of an intended one of the image frames, and a signal of command for printing.

The card reader 33 is loadable with the memory card 26 in a removable manner. When the memory card 26 is set at the card reader 33, the data files 28 and the index file 30 are retrieved by the order receiving device 12. The data files 28 of image data from the memory card 26 are written to the image data storage 34, from which the data files 28 are read opportunely for display and/or printing. Also, the index file 30 is sent to the index analyzer 36 for the purpose of image grouping, which will be described later in detail.

The image data processor 38 reads data files of image data stored in the image data storage 34, and produces thumbnail image data by thinning pixel information in the image data. According to the thumbnail image data, an image is displayed on the display panel 40. When the printing key 46 is depressed to enter a command signal, the index analyzer 36 produces printing data from the image data of the designated image frame, sends the printing data to the system controller 44 and then to the image forming device 42. In the image forming device 42, a printhead (not shown) is driven according to the printing data, to record an image to a recording sheet previously loaded in the image forming device 42.

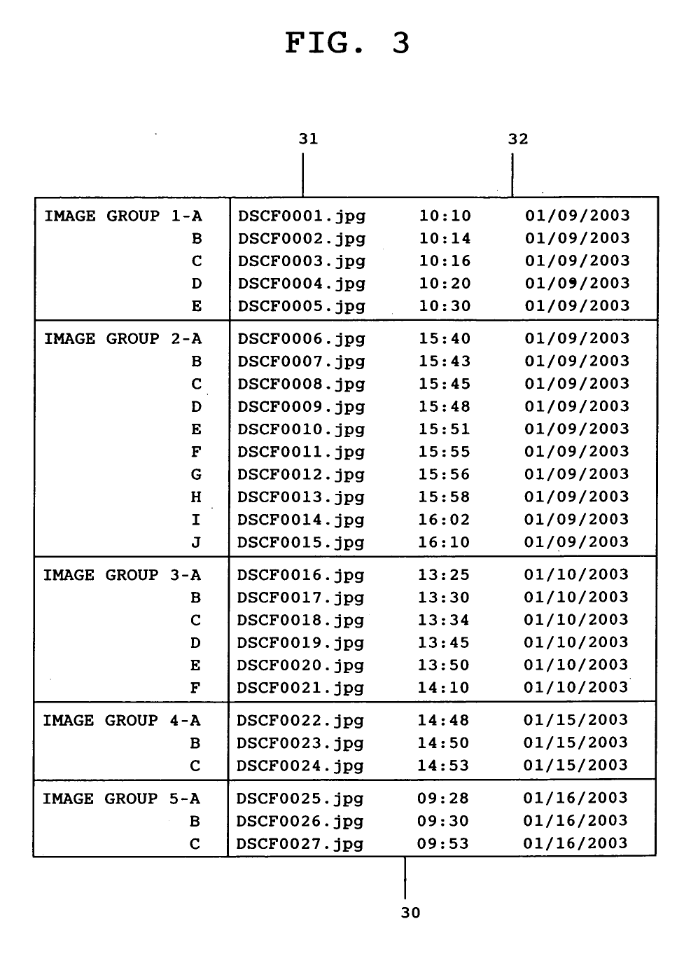

In FIG. 3, a grouping process of the index file 30 is described. Data according to the index file 30 is analyzed by the index analyzer 36, to retrieve chronological information of data files of all of the image frames.

The chronological information, having been determined by analyzing the index file 30, is evaluated to group the data files of image data. At first, a data file (DSCF0001.jpg) of a first image frame that is chronologically the oldest is determined as data file 1-A, which means a first image frame in image group No. 1. The sign 1-A is discernment information of the data file. A number portion of 1-A represents the image group. An alphabetical portion of 1-A is location information in each of the image groups, and determined in the alphabetical order by following the chronological sequence.

Then chronological information of a data file (DSCF0002.jpg) of an image data of a second image frame is compared with the chronological information of the data file (DSCF0001.jpg) of the first image frame. According to a result of the comparison, a time difference in the chronological information is checked shorter than a predetermined time, for example three (3) hours.

If the time difference is found shorter than three hours, then two consecutive image frames are determined relevant to each other. A data file of the second image frame is classified and included in image group No. 1. If the time difference is equal to or longer than three hours, then two consecutive image frames are determined irrelevant to each other. A data file of the second image frame is classified as a first image frame of image group No. 2. Similarly, a pair of two consecutive image frames is subjected to comparison of the chronological information. The time difference is evaluated by referring to the three hours, so as to group photographed image frames. When a group into which a final image frame is associated is determined, then the grouping operation is ended.

In the index file 30 of FIG. 3, a time difference between the data files (DSCF0001.jpg and DSCF0002.jpg) of image data of the first and second image frames is only four (4) minutes, which is shorter than three hours. Then it is judged that the data file (DSCF0002.jpg) of the second image frame is for the second image frame 1-B of image group No. 1. Similarly, it is judged that the data files of the image data (from DSCF0003.jpg to DSCF0005.jpg) of a series from a third image frame to a fifth image frame are a series from a third image frame 1-C to image group No. 1 to a fifth image frame 1-E in image group No. 1.

A time difference between the data file (DSCF0005.jpg) of the fifth image frame and a data file (DSCF0006.jpg) of the sixth image frame is five (5) or more hours. Then it is judged that the sixth data file (DSCF0006.jpg) is for an image frame 2-A or first image frame of the image group No. 2. A time difference between the sixth data file (DSCF0006.jpg) of the sixth image frame and a data file (DSCF0007.jpg) of the seventh image frame is as short as three (3) minutes. Then it is judged that the seventh data file (DSCF0007.jpg) is for an image frame 2-B or second image frame of image group No. 2.

All of the data files are grouped similarly. In the present embodiment, the index file 30 for 27 image frames is grouped into five zones for five image groups. See FIG. 3. For example, a data file (DSCF0018.jpg) of image data of an 18^{th} image frame is the third image frame 3-C of image group No. 3. Also, the number of image frames for each of the image groups is counted, and written to a memory provided in the system controller 44. Image frames 1-A, 2-A, 3-A, 4-A and 5-A located at respectively initial positions of the image groups are determined principal image frames of the image groups.

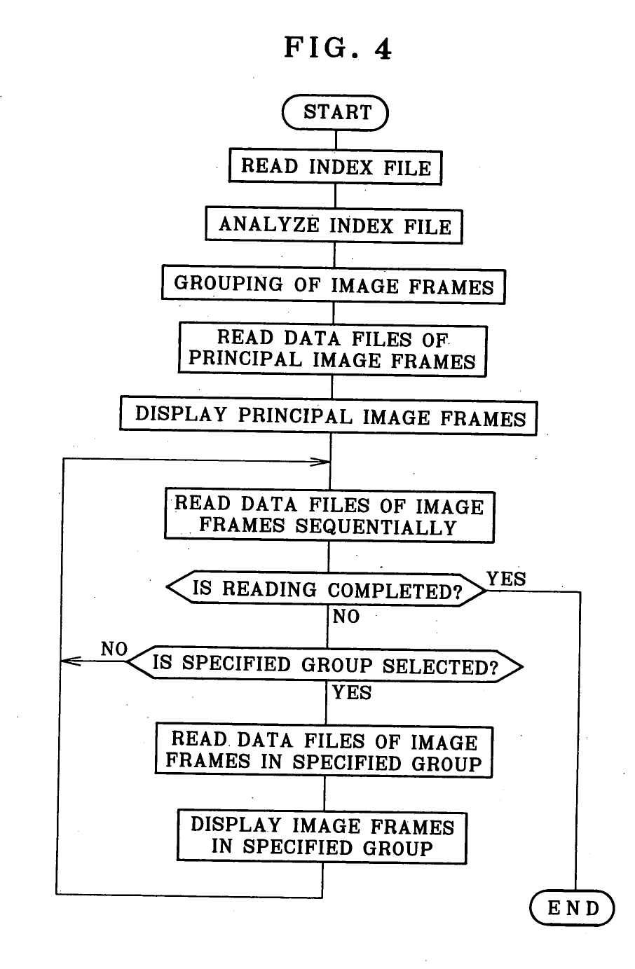

The process of data file reading and image displaying is described with reference to a flow chart of FIG. 4. When the memory card 26 is set at the card reader 33, the order receiving device 12 retrieves or reads the index file 30 to analyze the same. So the data files of the image data are grouped. Then data files of the principal image frames of respectively the image groups are sequentially retrieved or read from the memory card 26, to produce thumbnail image data. When production of thumbnail image data for all of the principal image frames is completed, the system controller 44 causes the display panel 40 to display the principal image frames in one line. Accordingly, a user viewing the display panel 40 is encouraged to select a desired one of the image groups for the purpose of selective printing.

Even after the principal image frames become displayed on the display panel 40, the system controller 44 continues accessing the memory card 26, and reads data files of image data of remaining image frames other than the principal image frames serially, so the system controller 44 produces thumbnail image data.

If one of the image groups is selected by a user in the course of reading of the data files, the system controller 44 effects interruption, and changes the reading order of the data files. Specifically, the selected image group is given priority, of which data files of intra-group image frames start being read earlier than the remainder, to produce thumbnail image data. Then the image frames of the specified image group are caused by the system controller 44 to appear on the display panel 40 in a state arranged crosswise to the arrangement of the principal image frames.

When all data files of image data in the memory card 26 are read and written to the image data storage 34, the system controller 44 discontinues the access to the memory card 26, and terminates the reading process.

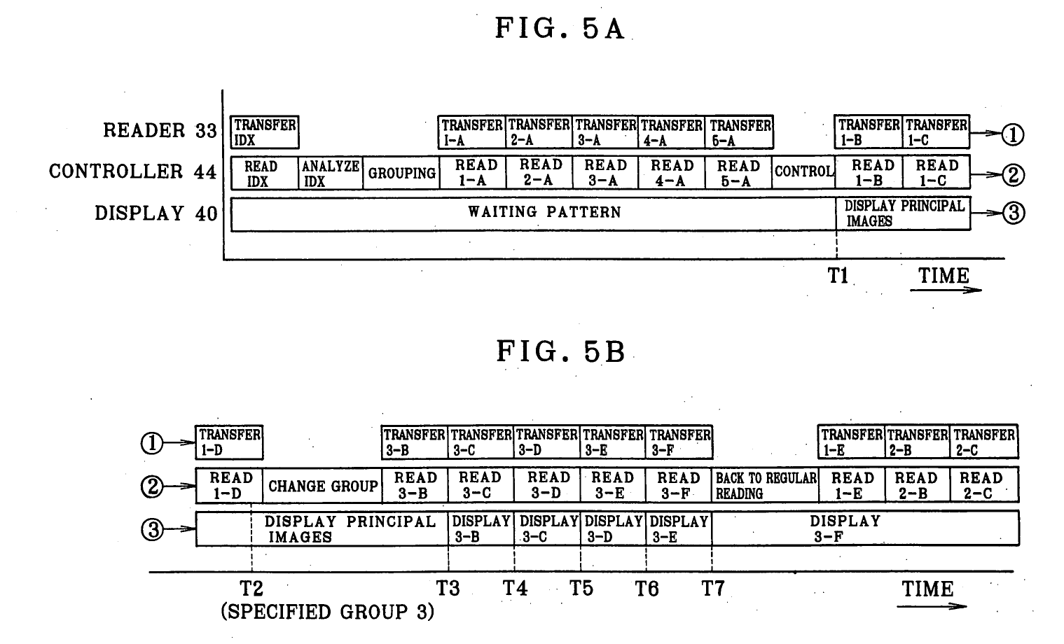

The operation of the embodiment is described by referring to a timing chart of FIG. 5. When the memory card 26 is set as an input, the order receiving device 12 reads the index file 30. The chronological information is analyzed. Data files of image data are grouped. For example, the index file 30 is grouped into image groups Nos. 1-5. See FIG. 3.

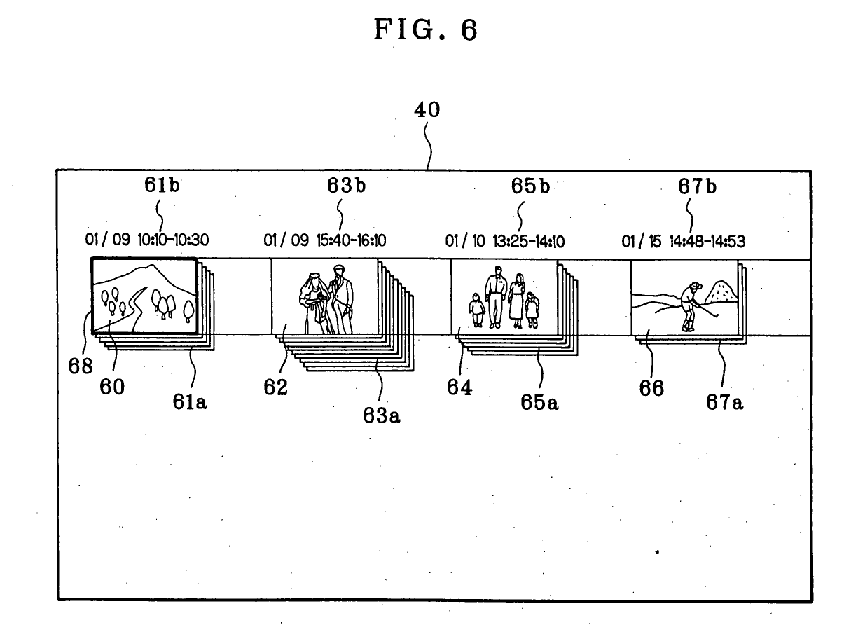

Upon the completion of grouping of the data files, the system controller 44 reads the data files of a series from 1-A to 5-A for principal image frames of the five image groups. Thumbnail image data of the five are produced. Upon producing all the thumbnail image data, a counter in the system controller 44 counts the number of data files of the image data belonging to each of the image groups. At time T1, the system controller 44 drives the display panel 40 to indicate a series of principal image frames 60, 62, 64 and 66. See FIG. 6. Note that the number of principal image frames displayed at one time may be changed as desired. In FIG. 6 for the present embodiment, four principal image frames of the five are displayed according to the setting. The principal image frame 64 in the embodiment will be specified as an intra-group principal image frame or target principal image frame. The principal image frame 60 is provided with a frame amount pattern or information 61a and information of a chronological zone 61b. The frame amount pattern 61a represents a quantity or number of image frames belonging to the first image group. The chronological zone 61b is a zone of a date and/or time of the pickup of image frames of the first image group. Similarly, the principal image frames 62, 64 and 66 are respectively provided with frame amount patterns or information 63a, 65a and 67a, and information of chronological zones 63b, 65b and 67b. The frame amount pattern 63a is for a second image group, the frame amount pattern 65a being for a third image group being a specified image group, the frame amount pattern 67a being for a fourth image group.

The frame amount patterns 61a, 63a, 65a and 67a are provided with a form respectively according to the number of image frames belonging to the image groups, and are indicated as if those were disposed behind the shapes of the principal image frames 60, 62, 64 and 66. This enables a user apparently to recognize the quantitative differences between the image groups in relation to the number of the image frames. Note that it is unnecessary to provide the frame amount patterns 61a, 63a, 65a and 67a with corners, edge lines, overlapped shapes or other symbolical features correctly reflecting the number of the image frames. The forms of the frame amount patterns 61a, 63a, 65a and 67a can be suitably modified. For example, forms of those may have corners or edge lines of a number which is smaller than the number of the actual image frames but is proportional to the latter. Also, forms of the frame amount patterns 61a, 63a, 65a and 67a may be plural symbolical indicia for plural ranks of numbers, for example three indicia for a high rank, a low rank, and a single-frame rank for one image frame.

The chronological zones 61b, 63b, 65b and 67b are expressions constituted by two value sets of the date and time of first and final image frames of each one of the image groups. A user observes the information to recognize a range of the date and time of image frames. In FIG. 6, each of the chronological zones 61b, 63b, 65b and 67b has portions for the month, day, hour and minute. However, the year, the second or the like may be additionally provided in the chronological zones. Signs of a.m. and p.m. may be added at the value of the time. Furthermore, the indication of the minute can be omitted. Each chronological zone may include the month, day and hour, in such a manner as 01/09, 15-16 o'clock.

The principal image frames 60, 62, 64 and 66 of the image groups are such photographed at a considerably long interval between those, for example three (3) hours or more. This is effective in grouping the image frames between plural distinct scenes, because the user or the digital camera may be located unrelatedly in a different scene after lapse of considerable time. In contrast, image frames included in a common image group can be related closely to one another, because time intervals between those are considerably short with reference to the predetermined time. Therefore, the user is enabled to discern or imagine which of the scene he or she is interested in for the purpose of previously estimating the location of any desired one of all the image frames.

The system controller 44 continues reading data files of image data from the memory card 26 sequentially even while the display panel 40 indicates the principal image frames 60, 62, 64 and 66 for a user to select one image group. In FIG. 5, image frames of image group No. 1 are read in the order from the second image frame 1-B, the third image frame 1-C up to the fifth and final image frame 1-E. Immediately after this, data files of image group No. 2 start being read. Similarly, data files of any of the image groups are read.

For example, if a user wishes prints of a group photograph, such as a scene of his or her family, he or she can recognize that one or more intended image frames are included in the image group indicated with the principal image frame 64. A movable pointing frame pattern 68 or cursor pattern is shifted horizontally by operation of the selection cursor key 48, and set at the principal image frame 64 in the third position. The confirming button 50 is depressed at the time point T2. Then the system controller 44 retrieves or reads the data file 1-D in response to the depression. After this, the system controller 44 reads data files of the intra-group image frames of image group No. 3, namely from data file 3-B to data file 3-F. Thumbnail image data are produced sequentially. Image frames according to data files from 3-B to 3-F are displayed one after another at time points from T3 to T7. After this, data files of image data not being read yet are read by the system controller 44 from the oldest to the newest in a chronological sequence. When all the data files are read, the reading process is completed.

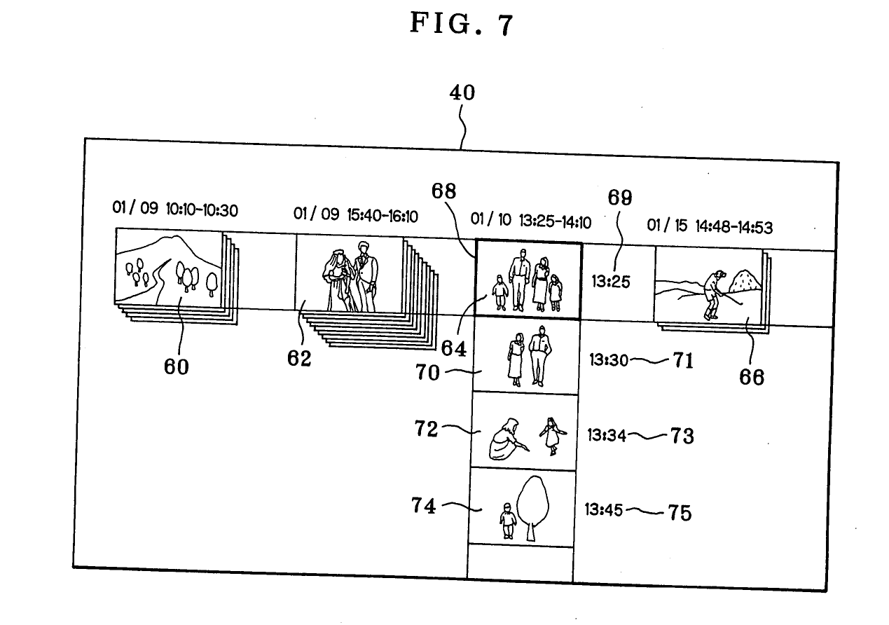

In FIG. 7, intra-group image frames belonging to image group No. 3 being selected are displayed and arranged in a vertical direction crosswise to the series of the principal image frames. Image group No. 3 includes the intra-group principal image frame 64 and remaining intra-group image frames 70, 72 and 74 or target image frames. Note that the number of commonly grouped image frames displayed at one time may be changed as desired. In FIG. 7, four image frames are displayed according to the setting despite the five image groups in all. Time information 69 as chronological information is indicated near to the intra-group principal image frame 64, to inform a user on the time of the pickup of the image. Time information 71, 73 and 75 as chronological information is indicated near to respectively the intra-group image frames 70, 72 and 74 similarly. In the reading operation, the data files of image data of the specified image group are given priority over the remainder. This is effective in quickening the display operation of the image frames in the image group. Waiting time of the user can be reduced. The direction of the series constituted by the image frames of the single image group is crosswise to and distinct from the direction of the series of the principal image frames. This is effective in impressing a user with the same time zone according to which the image frames have been grouped.

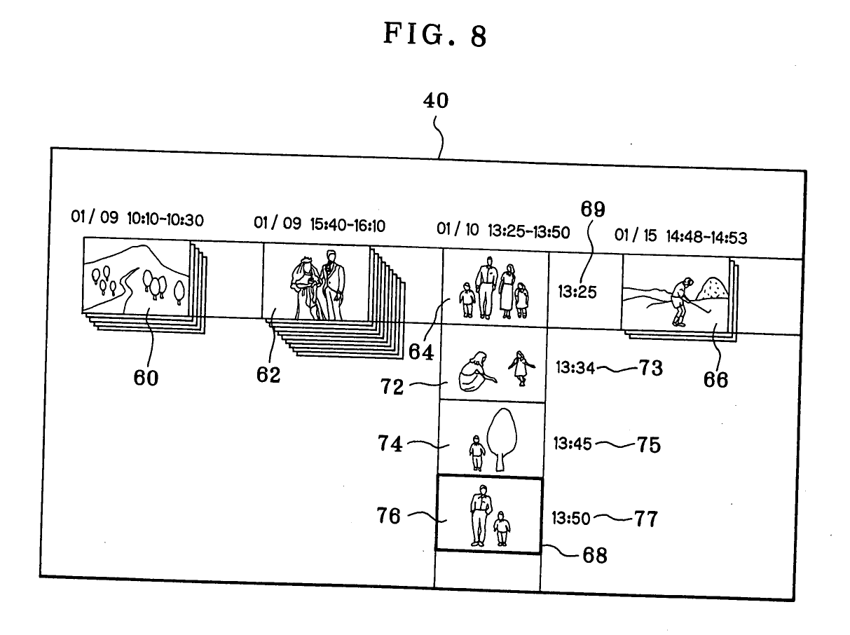

Then the pointing frame pattern 68 is shifted up or down vertically by use of the selection cursor key 48, to select an intended one of the image frames. If the user wishes to select a fifth image frame not displayed presently in the display panel 40, he or she sets the pointing frame pattern 68 at the intra-group image frame 74, and operates the selection cursor key 48. In FIG. 8, the intra-group image frames 72 and 74 are scrolled up. An intra-group image frame 76 or target image frame of the fifth position becomes displayed on the display panel 40 together with time information 77 as chronological information. The intra-group image frame 70 of the second position is caused to disappear from the display panel 40.

When the pointing frame pattern 68 is positioned at a desired image frame, the printing key 46 is depressed to enter a signal of command for printing. A data file of the image data of the selected image frame is read, and transferred to the image forming device 42, which prints the image frame. If an image frame of a second image group is desired, the confirming button 50 is depressed to suppress indication of image frames of image group No. 3 on the display panel 40, so the display panel 40 comes back to the state of FIG. 6. The pointing frame pattern 68 is set at the principal image frame of the desired specified image group. The confirming button 50 is depressed again. If data files of image data of the specified image group have not been read yet, data files for the specified image group are read with priority over the remainder, to display image frames of the image group similarly. Consequently, the image frames can be searched and selected with high efficiency because of grouping of image frames by referring to the time interval of the pickup for initial indication of only the principal image frames. Also, time required for the search and selection can be shortened.

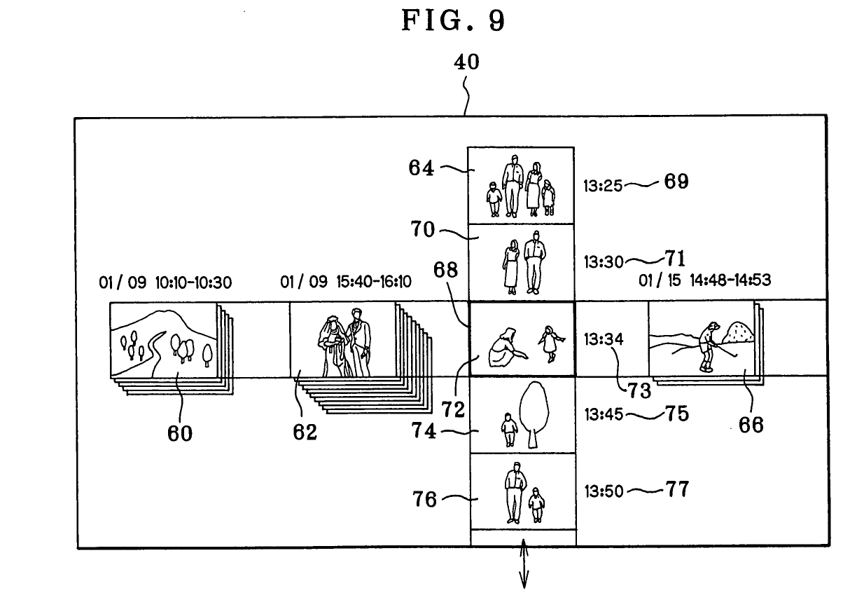

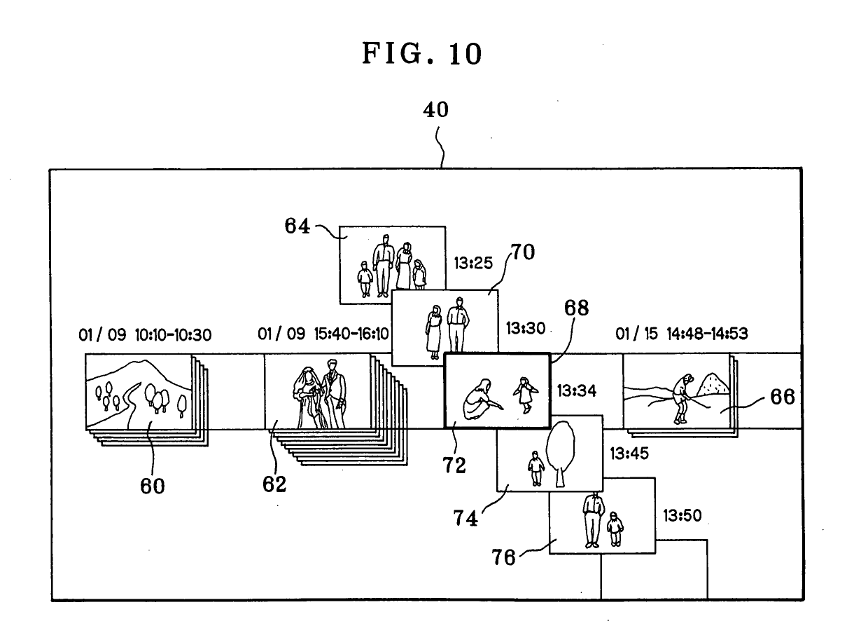

In the above embodiment, the pointing frame pattern 68 is moved up or down to select one of the image frames. In FIG. 9, another preferred embodiment is illustrated, in which the pointing frame pattern 68 is stationary relative to the vertical direction. The series of the intra-group image frames in the specified image group is entirely scrolled up or down, so that an intended one of the intra-group image frames can be set at the pointing frame pattern 68. In FIG. 10, a further example is illustrated, in which a series of intra-group image frames belonging to a specified image group extends in an oblique up-and-down direction instead of the vertical direction. Furthermore, the intra-group image frames arranged with the inclination as a specified image group can have a smaller size than the principal image frames in the series. This makes it possible to display image frames in a higher number even at one time.

In the above embodiments, intra-group image frames in a specified image group are arranged in a series oriented between lower and upper sides, the series in a second direction being crosswise to a first direction of the series of the principal image frames. However, the second direction may be any suitable direction that is crosswise to the first direction. For example, a second direction of the series of intra-group image frames of a specified image group may be curved, or may be an L-shape or a channel-shape as a combinations of two or more straight short lines. Any one portion of the set of the plural straight lines may be parallel to the first direction of the principal image frames.

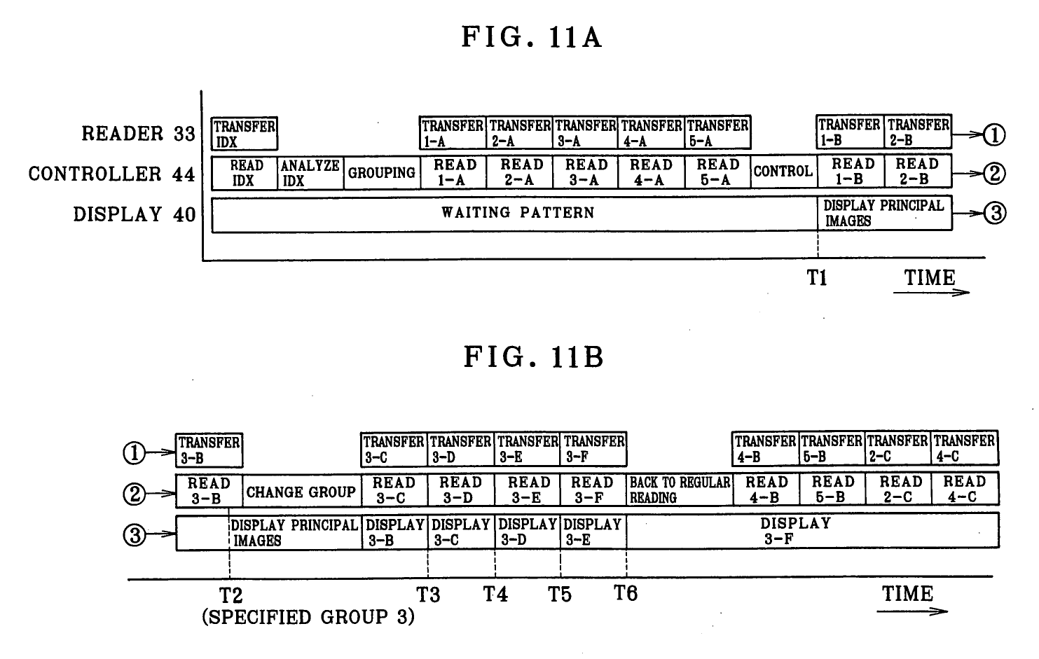

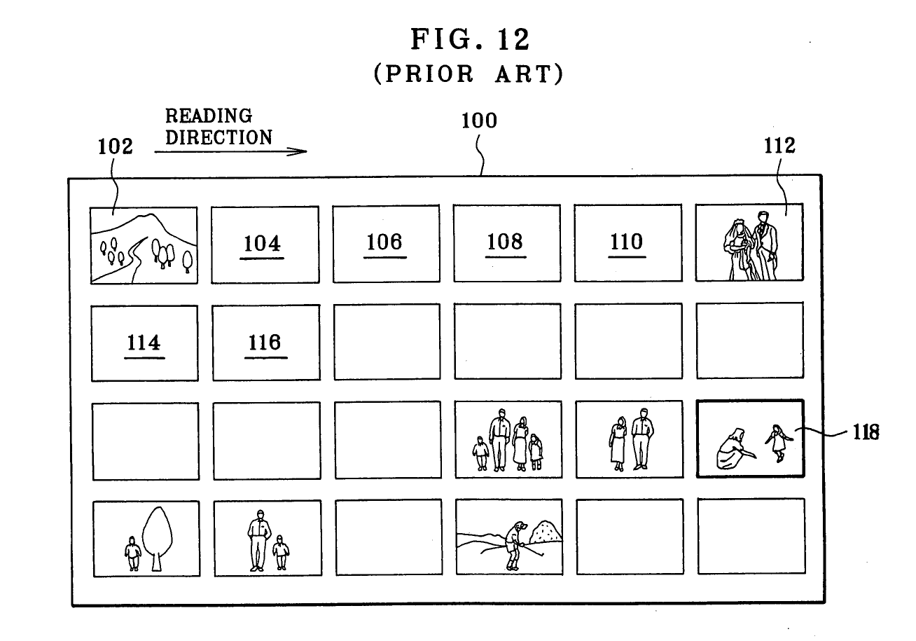

In the above embodiments, the data files of the image data are read in the chronological order while no image group is selected. However, other processes of reading or retrieving data files of image data can be used. In a timing chart of FIG. 11, a preferred embodiment of reading is illustrated. After the principal image frames of image groups are displayed, data files from 1-B to 5-B of second image frames in respectively the image groups are read or retrieved. After this, the system controller 44 reads data files of image frames one after another for each of the image groups. In the present embodiment, image group No. 3 is selected at time T2. The data file 3-B of the second image frame of image group No. 3 has been read already before the selection of image group No. 3. Thus, it is possible to shorten time for reading data files of image data of image group No. 3.

In the above embodiments, the first of the image frames belonging to each image group is determined as principal image frame. However, any suitable one of the image frames belonging to each image group can be determined as principal image frame. When all the data files of the image data associated with respectively the image groups are read, the principal image frames being displayed may be a combination of two or more of the image frames connected together. Also, all the image frames of a common one of the image groups may be displayed sequentially and cyclically at one interval of time. If a human body is included in any one of the image frames according to a result of analyzing the data files of the image data being read, it is possible to designate the human image frame as principal image frame with higher priority. Furthermore, some of the image frames may be judged as a failing image frame, such as image frames with extremely low brightness or with extremely low proportion of high frequency. Such failing image frames can be prevented from designation as principal image frames, and from being displayed initially.

In the above embodiments, the plural image frames chronologically consecutive to one another are subjected to evaluation of the time interval, to group the image frames. However, other processes of grouping may be used in the invention. For example, the chronological information of one image frame is compared to chronological information of each first one of image frames of the image groups. If a time interval between those is shorter than a predetermined value, the one image frame is judged to belong to the associated image group. This process can be used effectively for the grouping operation.

In the above embodiment, the shortest length of the reference time as unit time is one minute. However, chronological information may be measured per a longer unit time, for example, two minutes or five minutes. Also, chronological information may be measured per a shorter unit time, for example, ten seconds. Furthermore, a set of plural chronological zones according to the present invention can be morning, afternoon and evening time zones, which are at most three or four, and can be irrespective of the date or year.

In the above embodiments, the digital still camera 10 is loaded with the memory card 26 so as to write data files of image data to be read or retrieved. However, other storage media may be used to store data files of image data and an index file. Examples of storage media include CD-ROM, MO disk, floppy disk (trade name), micro drive (trade name), ZIP disk (trade name), and the like. The order receiving device 12 is loaded with such a storage medium of any type, for reading data files of image data.

In the above embodiments, the image frames are displayed according to the thumbnail image data produced after reading the data files of the image data. However, it is possible that data files stored in the memory card 26 previously include thumbnail image data. In this case, the thumbnail image data from the data files of the image data can be used without changes for the purpose of displaying image frames.

In the above embodiments, the index file is produced in the digital still camera 10. However, an index file may be produced in the order receiving device 12 subsequently. To this end, a memory card is previously used to store information including data file names of image data, and chronological information. The information in combination is initially read, so the order receiving device 12 produces an index file according thereto. The order receiving device 12 then analyzes the index file, in order to group the data files of the image data.

In the above embodiments, the order receiving device 12 is provided with the image forming device for printing. However, the order receiving device 12 may be separate from a device for image forming. For example, a system of the invention may be such in which data files of specified image data may be written to a separate storage medium, which may be forwarded to a dealer, shop or agent commercially specialized in producing prints. The dealer, shop or agent provides prints to the user or customer together with the storage medium. In this way, the system includes the digital camera, storage medium, and all equipment used by the dealer, shop or agent. Furthermore, an order for printing may be placed through the Internet or other network system. Image data stored in a memory card may be displayed on a display panel by a general-purpose computer connected with the display panel.

In the above embodiments, a user enters a signal for command or selecting one specified image group after all of the four principal image frames become displayed. However, he or she may enter a signal for command or selecting one specified image group in the course of becoming displayed of all of the principal image frames. At this time, operation of interruption is effected in the reading of the principal image frames of the remaining image groups. Data files for remaining image frames belonging in the selected specified image group can be read with priority over the remainder.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An image displaying method of displaying plural image frames on a display panel, wherein image data of said image frames are stored in a data storage with chronological information, said image displaying method comprising steps of:
A. obtaining a chronological interval between said image frames according to said chronological information;
B. grouping said plural image frames into plural image groups according to a length of said chronological interval;
C. determining a principal image frame of each of said image groups and one or more intra-group image frames which are included in each of said image groups but different from said principal image frame;
D. displaying a plurality of said principal image frame on said display panel in a state arranged along a first line;
E. specifying one of said plural principal image frames, to determine a specified principal image frame;
F. displaying at least one intra-group image frame on said display panel in a state arranged along a second line different from said first line, said at least one intra-group image frame being included in an image group of said specified principal image frame.

2. An image displaying method as defined in claim 1, wherein said second line intersects with said first line at said specified principal image frame.

3. An image displaying method as defined in claim 2, further comprising steps of:
G. reading said chronological information from said data storage;
H. after said step C, reading said image data of said principal image frames from said data storage;
I. after said step D, reading said image data of said intra-group image frames from said data storage.

4. An image displaying method as defined in claim 3, wherein if said step E occurs during said step I, said image data of said intra-group image frames included in said image group having said specified principal image frame are read with priority from said data storage.

5. An image displaying method as defined in claim 4, wherein in said step I, said image data of said intra-group image frames are read in a sequence determined by said chronological information.

6. An image displaying method as defined in claim 4, wherein in said step I, said image data of said intra-group image frames are read for one image frame per one image group and also in an sequence of said image groups.

7. An image displaying method as defined in claim 3, further comprising a step of displaying frame amount information on said display panel in association with said principal image frames, said frame amount information representing an amount of said intra-group image frames included in respectively said image groups.

8. An image displaying method as defined in claim 7, wherein said frame amount information has a form of at least one sub-frame, and is disposed to overlap on said principal image frames in said display panel, and a number of said at least one sub-frame is substantially proportional to said amount of said intra-group image frames included in an associated one of said image groups.

9. An image displaying method as defined in claim 3, further comprising a step of displaying information of a chronological zone of said image frames derived from said image groups on said display panel near to respectively said principal image frames.

10. An image displaying method as defined in claim 2, wherein said second line is substantially perpendicular to said first line.

11. An image displaying method as defined in claim 3, further comprising steps of:
L. determining said principal image frame for one of said image groups of which reading of said image data of said intra-group image frames is completed;
M. displaying said principal image frame on said display panel in a renewed manner according to a result of said step L.

12. An image displaying method as defined in claim 11, wherein said steps L and M are executed periodically at a regular period.

13. An image displaying method as defined in claim 11, wherein said principal image frame determined in said step L is a frame of a human image.

14. An image displaying method as defined in claim 3, further comprising:
combining a plurality of said intra-group image frames for one of said image groups of which reading of said image data of said intra-group image frames is completed, to produce a combined image frame;
displaying said combined image frame on said display panel in a renewed manner for said principal image frame.

15. An image displaying method as defined in claim 1, wherein said data storage further stores an index file for associating said image frames with said chronological information;
further comprising steps of:
before said step A, reading said index file;
if said chronological interval between two of said image frames is smaller than a predetermined value, determining that said two image frames are included in a common one of said image groups;
if said chronological interval between said two image frames is equal to or greater than said predetermined value, determining that said two image frames are included in two distinct image groups of said image groups.

16. An image displaying method as defined in claim 1, wherein a combination of said image data and said chronological information constitutes a data file;
further comprising steps of:
before said step A, reading said chronological information from said data file;
producing an index file for associating said image frames with said chronological information;
if said chronological interval between two of said image frames is smaller than a predetermined value, determining that said two image frames are included in a common one of said image groups;
if said chronological interval between said two image frames is equal to or greater than said predetermined value, determining that said two image frames are included in two distinct image groups of said image groups.

17. An image displaying method as defined in claim 1, further comprising steps of:
displaying an indicator on said display panel for selectively pointing said image frames;
moving said indicator on said first line, in order to specify said principal image frames on said display panel.

18. An image displaying method as defined in claim 17, further comprising a step of moving said indicator on said second line, in order to specify one of said intra-group image frames included in said image group having said specified principal image frame.

19. An image displaying method as defined in claim 17, further comprising a step of displaying said intra-group image frames included in said image group having said specified principal image frame in a shiftable manner on said second line.

20. An order receiving device for displaying plural image frames on a display panel, and for receiving an order according to selection of said image frames to be reproduced, wherein image data of said image frames are stored in a data storage with chronological information, said order receiving device comprising:
a transferring unit for reading said image data and said chronological information from said data storage;
a chronology analyzer for obtaining a chronological interval between said image frames according to said chronological information, for grouping said plural image frames into plural image groups according to a length of said chronological interval, and for determining a principal image frame of each of said image groups and one or more intra-group image frames which are included in each of said image groups but different from said principal image frame;
a controller for driving said display panel to display a plurality of said principal image frame in a state arranged along a first line;
a selector for specifying one of said plural principal image frames, to determine a specified principal image frame;
wherein said controller drives said display panel to display at least one intra-group image frame in a state arranged along a second line different from said first line, said at least one intra-group image frame being included in an image group of said specified principal image frame.

21. An order receiving device as defined in claim 20, wherein said second line intersects with said first line at said specified principal image frame.

22. An order receiving device as defined in claim 21, wherein said transferring unit reads said image data of said principal image frames from said data storage, and upon displaying said principal image frames on said display panel, reads said image data of said intra-group image frames from said data storage.

23. An order receiving device as defined in claim 22, wherein upon specifying one of said principal image frames while said image data of said intra-group image frames are read, said image data of said intra-group image frames included in said image group having said specified principal image frame are read with priority from said data storage.

24. A system adapted to receiving an order, comprising:
a pickup device for producing image data of image frames by pickup thereof, to write chronological information and said image data to a data storage; and
an order receiving device for displaying plural image frames on a display panel, and for receiving said order according to selection of said image frames to be reproduced, said order receiving device including:
a transferring unit for reading said image data and said chronological information from said data storage;
a chronology analyzer for obtaining a chronological interval between said image frames according to said chronological information, for grouping said plural image frames into plural image groups according to a length of said chronological interval, and for determining a principal image frame of each of said image groups and one or more intra-group image frames which are included in each of said image groups but different from said principal image frame;
a controller for driving said display panel to display a plurality of said principal image frame in a state arranged along a first line;
a selector for specifying one of said plural principal image frames, to determine a specified principal image frame;
wherein said controller drives said display panel to display at least one intra-group image frame in a state arranged along a second line different from said first line, said at least one intra-group image frame being included in an image group of said specified principal image frame.

25. A system as defined in claim 24, wherein said second line intersects with said first line at said specified principal image frame.

26. A system as defined in claim 25, wherein said transferring unit reads said image data of said principal image frames from said data storage, and upon displaying said principal image frames on said display panel, reads said image data of said intra-group image frames from said data storage.

27. A system as defined in claim 26, wherein upon specifying one of said principal image frames while said image data of said intra-group image frames are read, said image data of said intra-group image frames included in said image group having said specified principal image frame are read with priority from said data storage.
